(19) United States
(12) Patent Application Publication
(10) Pub. No.: US 2002/0034298 A1
(43) Pub. Date: Mar. 21, 2002

(54) LAN user protocol

(75) Inventors: Michael Gallagher, Southampton (GB); Robert Hancock, Southampton (GB)

Correspondence Address: Crowell & Moring L.L.P., Intellectual Property Group, P.O. Box 14300, Washington, DC, 20044-4300, US

(73) Assignee: Roke Manor Research Limited.

(21) Appl. No.: 09/953,369

(22) Filed: Sep. 17, 2001

(30) Foreign Application Priority Data
Sep. 15, 2000 (GB) 0022604.3

(51) Int. Cl. H04L 9/32; H04M 1/66

(52) U.S. Cl. 380/247; 713/155; 455/411

(57) ABSTRACT

The invention provides an operating protocol for Local Area Network (LAN) systems capable of coping with the problems of user-mobility between LANs. Such mobility is afforded particularly by wireless LAN (WLAN) systems, whereby a user subscribing to a LAN operated by a so-called Home Operator connects, as a “visitor”, to one or more other LAN sites; basing such connection, for charging and other operational purposes, on that user's subscription with its Home Operator. The inventive protocol links a user's identity with the address of the Home Operator, and stores this information at the visited LAN site, thereby permitting a visiting user, once authenticated by user-interaction, as a visitor with regard to a particular LAN, to revisit that LAN for as long as its authentication with the Home Operator remains sound, without the need for further user intervention.

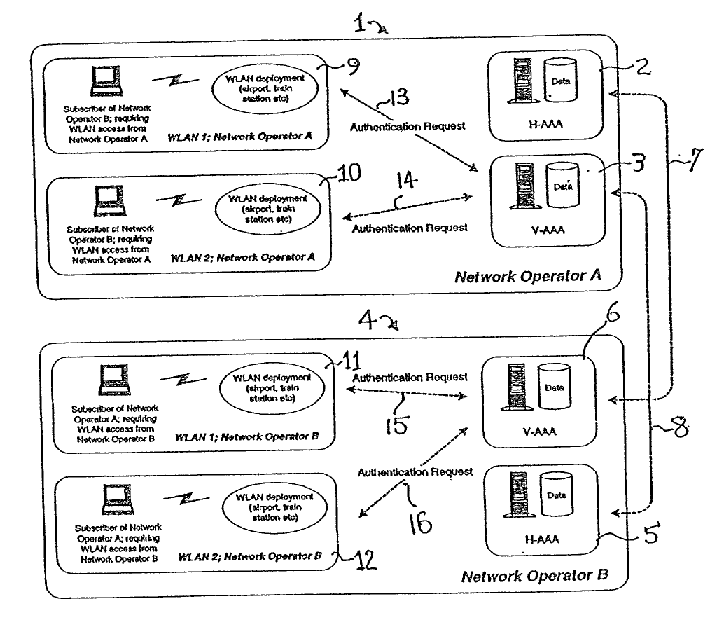

This invention relates to operating protocols for Local Area Network (LAN) systems, and it relates especially to such protocols as can cope with the problems of user-mobility between LANs, as afforded particularly by wireless LAN (W-LAN) systems.

In W-LAN systems, it is often the case that a user, subscribing with one network operator (hereinafter called “the Home Operator” for that user), wishes to connect, as a “visitor”, to one or more other LAN sites; basing such connection, for charging and other operational purposes, on that user's subscription with its Home Operator. This activity is commonly referred to as Wireless-LAN roaming, and existing protocols permitting the activity are cumbersome, as the necessary authentication procedure requires user intervention at each visit.

This invention provides a protocol that permits a visiting user, once authenticated as a visitor with regard to a particular LAN, to revisit that LAN for as long as the user's authentication with the Home Operator remains sound, without further user intervention.

According to the invention there is provided a user protocol for WLAN systems whereby the operator of each LAN administers home (H) network and Visitor (V) network authentication, authorisation and accounting (AAA) servers and wherein a subscriber to a first LAN wishing to connect for the first time to a second LAN conveys to the operator of the second LAN, by user intervention, information, identifying both the subscriber and the operator of the first LAN, sufficient to enable the V-AAA server of the second LAN to communicate with the H-AAA server of the first LAN so as to authenticate the proposed connection; the V-AAA storing information linking the subscriber to the operator of the first LAN for so long as the subscriber remains authorised by the operator of the first LAN, whereby subsequent connections by the subscriber to the second LAN may be made without user intervention.

This is achieved because the subscriber's identity, when announced to the second LAN as part of the routine connect procedure, is correlated by the V-AAA server with the previously-given identity of the H-AAA server for that subscriber, and the V-AAA automatically communicates with the HAAA to derive the necessary authorisation and to organise the necessary charging, etc.

The V-AAA thus stores the subscriber/H-AAA linking data until such time as the H-AAA supplies it with information to the effect that the subscriber's authorisation is no longer valid or until an authentication transaction with the H-AAA fails. At this point the link is broken, and subsequent attempts by the subscriber to connect with the second LAN will fail, unless they are, as a result of further user-intervention, shown to be authorised by the H-AAA server of another LAN system.

Preferably, the information supplied by the subscriber, by way of user intervention, includes the subscriber's MAC address and an identifier, such as a user name or MSISDN number, that allows the operator of the subscriber's Home Network to be identified.

This permits the V-AAA server of the second LAN operator to utilise the identifier to locate the H-AAA server of the Home Operator for that subscriber, and to request the H-AAA server to authenticate the desired connection. Once this has been performed, charging information for the session can be forwarded to the H-AAA enabling the H-AAA operator to bill the user and make payment to the visited LAN reporter.

Further, when that subscriber connects to the second LAN on a subsequent occasion, the information held at the V-AAA server of the second LAN and linking the subscriber's address to the Home Network identifier, allows authentication of the requested connection to be effected automatically and without user intervention on the part of the subscriber.

In order that the invention may be fully understood and readily carried into effect, one embodiment thereof will now be described, by way of example only, with reference to the accompanying drawing, the single figure of which shows, in schematic form, the operation of a protocol in accordance with one embodiment of the invention.

Referring now to the drawing, there is shown schematically within the outline 1 a LAN operated by a first network operator A. Operator A operates H-AAA and V-AAA servers, 2 and 3 respectively, in respect of the LAN 1. Subscribers to the network 1 are operating on their Home Network, and thus communicate with the H-AAA server 2 for all operational and charging purposes related to connections to that LAN.

Similarly, there is shown schematically within the outline 4 a LAN operated by a second network operator B. Operator B operates H-AAA and V-AAA servers, 5 and 6 respectively, in respect of the LAN 4. Subscribers to the network 4 are operating on their Home Network, and thus communicate with the H-AAA server 5 for all operational and charging purposes related to connections to that LAN.

As indicated by the dashed line connections 7 and 8, the H-AAA server 2 is in communication with the V-AAA server 6 and, indeed with the V-AAA servers of further LAN systems (not shown) to which subscribers to the LAN 1 may make connection as visitors. Likewise, the H-AAA server 5 is in communication with the V-AAA server 3 and, indeed with the V-AAA servers of further LAN systems (not shown) to which subscribers to the LAN 4 may make connection as visitors.

Within the outline 1 there are shown schematically first and second subscribers 9 and 10, these being subscribers of the network 4 but wishing to connect to the network 1. Likewise, within the outline 4 there are shown schematically first and second subscribers 11 and 12, these being subscribers of the network 1 but wishing to connect to the network 4. These are visiting subscribers and, in each case and on the first occasion of such connection, there will have to be user intervention to establish the flow of sufficient information, between such subscribers and the V-AAA server of the network to which they wish to connect, to permit the necessary authorisations and charging procedures to be out in place. This user intervention and the associated information flow is indicated schematically by the dashed lines 13-16.

As part of the initial process setting up the relationship between each subscriber and its Home Network Operator, the subscriber is given an identifier which also identifies its Home Network in some convenient standardised way, such as NAI or MSISDN for example.

When that subscriber first seeks to connect, as a visitor, to another network, the subscriber is, as part of a setting-up procedure requiring user intervention, called upon to identify itself, for example by its MAC address or any other id that is automatically provided during normal WLAN authentication procedures, and also to enter an identifier, such as a user name or MSISDN, that allows the subscriber's Home Network to be determined. Utilising that identifier, the V-AAA server locates the H-AAA server at the subscriber's Home Network and seeks authentication of the subscriber.

Assuming that such authentication is forthcoming, the V-AAA server keeps a copy of the MAC address of the subscriber's WLAN device, along with the H-AAA identifier. This information, which links the identity of subscriber's WLAN device to that of its home network, is stored by the V-AAA for future use. Hence, when the subscriber seeks connection to that LAN on subsequent occasions, the linked identification data permits the necessary authentication to proceed without user intervention. This state of affairs persists for as long as the subscriber remains authenticated by the same Home Network, and is true for all public LANs within the administrative control of the same visitor network operator. Once authentication fails, the linked identification data are purged, with the consequence that automatic authentication of that subscriber as a visitor to a LAN will cease, unless or until the subscriber establishes, through a repeat of the initial process involving user intervention, accreditation by a new Home Operator.

The invention permits operators to add new LAN sites to their operations without modifying externally established trust relationships, and moreover to add new partner operators without modifying internal trust relationships.

It may be appropriate, depending upon the nature of any rules controlling the extent to which W-LAN subscribers can roam, to associate each MAC address (or other device identifier) with a W-LAN network type, so that MAC addresses or other identifiers that are shared by different WLAN technologies, such as IEEE 802.11 and Bluetooth, are not ambiguous.

Although the invention has been described with regard to one particular embodiment thereof, it is not intended that the scope of the claims of this application be limited to that embodiment, and alternative arrangements will be evident in many respects to those skilled in the art. For example, the H-AAA and V-AAA servers (such as 2 and 3) associated with any given LAN need not consist of respective, stand-alone units, as shown in the drawing, but may instead be combined into a common unit.

1. A user protocol for W-LAN systems whereby the operator of each LAN administers home (H) network and Visitor (V) network authentication, authorisation and accounting (AAA) servers and wherein a subscriber to a first LAN wishing to connect for the first time to a second LAN conveys to the operator of the second LAN, by user intervention, information, identifying both the subscriber and the operator of the first LAN, sufficient to enable the V-AAA server of the second LAN to communicate with the H-AAA server of the first LAN so as to authenticate the proposed connection; the V-AAA storing information linking the subscriber to the operator of the first LAN for so long as the subscriber remains authorised by the operator of the first LAN, whereby subsequent connections by the subscriber to the second LAN may be made without user intervention.

2. A protocol according to claim 1 wherein the subscriber's identity, when announced to the second LAN as part of the routine connect procedure, is correlated by the V-AAA server with the previously-given identity of the H-AAA server for that subscriber, and the V-AAA automatically communicates with the H-AAA to derive the necessary authentication and authorisation and subsequently delivers accounting information.

3. A protocol according to claim 2 wherein the V-AAA stores the subscriber/H-AAA linking data until such time as the H-AAA supplies it with information to the effect that the subscriber's authorisation is no longer valid or until an authentication transaction fails.

4. A protocol according to claim 3 wherein, in order to re-establish connection to the second LAN, the subscriber demonstrates, as a result of further user-intervention, authorisation deriving from an H-AAA server of another LAN system.

5. A protocol according to any preceding claim wherein the information supplied by the subscriber, by way of user intervention, includes the subscriber's MAC address or any other automatically presented identifier and an identifier that allows the operator of the subscriber's Home Network to be identified.

6. A protocol according to claim 5 wherein said identifier comprises a user name or MSISDN number.

7. A protocol according to claim 5 or claim 6 wherein the V-AAA server of the second LAN operator utilises the identifier to locate the H-AAA server of the Home Operator for that subscriber, and to request the H-AAA server to authenticate the desired connection.

8. A W-LAN protocol substantially as herein described with reference to the accompanying drawing.
